(19) United States
(12) Patent Application Publication
(10) Pub. No.: US 2019/0330108 A9
(43) Pub. Date: Oct. 31, 2019

(54) RHEOLOGY MODIFIER FOR INORGANIC SUSPENSIONS

(71) Applicant: BASF SE, Ludwigshafen (DE)

(72) Inventors: Michael SCHINABECK, Altenmarkt (DE); Oliver MAZANEC, Rosenheim (DE); Nina Susanne HILLESHEIM, Mannheim (DE); Diana EISSMANN, Tacherting (DE); Stefan FRIEDRICH, Garching (DE)

(21) Appl. No.: 15/527,798

(22) PCT Filed: Nov. 19, 2015
(86) PCT No.: PCT/EP2015/077030

§ 371 Date: May 18, 2017

(30) Foreign Application Priority Data
Nov. 20, 2014 (EP) 14194051.0

(51) Int. Cl. C04B 24/16; C04B 24/26; C04B 28/00; C04B 40/00

(52) U.S. Cl. CPC C04B 24/165; C04B 24/2647; C04B 2103/44; C04B 40/0042; C04B 28/00

(57) ABSTRACT

The invention relates to a composition comprising (α) at least one water-soluble polymer based on (a) 5 to 40 wt % of at least one monomer of the formula (I) and (b) 5 to 95 wt % of at least one monomer (b) which comprises acid groups and is different from monomer (a), and (β) at least one associative thickener. Further disclosed is a mixture comprising an inorganic binder and also the composition of the invention. A further aspect of the present invention is the use of the composition of the invention as a rheological additive.

The present invention relates to a composition comprising at least one water-soluble polymer based on monomers having specific polyether side chains and also on monomers comprising acid groups, the composition further comprising at least one associative thickener. Disclosed in particular is a mixture comprising an inorganic binder and the composition of the invention. A further aspect of the present invention is the use of the composition of the invention as a rheological additive.

In order to impart improved workability, i.e., kneadability, spreadability, sprayability, pumpability or flowability, to inorganic solids suspensions, it is common to add additives to them in the form of dispersants or plasticizers. In the construction industry, such inorganic solids usually comprise inorganic binders such as, for example, cement based on Portland cement (EN 197), cement having particular properties (DIN 1164), white cement, calcium aluminate cement or high-alumina cement (EN 14647), calcium sulfoaluminate cement, specialty cements, calcium sulfate n-hydrate (n=0 to 2), lime or building lime (EN 459), and also pozzolans or latent hydraulic binders such as, for example, flyash, metakaolin, silica dust, slag sand. The inorganic solids suspensions further generally comprise fillers, more particularly aggregates consisting for example of calcium carbonate, quartz or other natural rocks in various particle sizes and particle morphologies, and also further inorganic and/or organic additives (admixtures) for the controlled influencing of properties of chemical construction products, as for example hydration kinetics, rheology or air content. Also present may be organic binders such as latex powders, for example.

In order to convert building material mixtures, especially those based on inorganic binders, into ready-to-use, workable form, it is generally necessary to use substantially more mixing water than is theoretically required for the subsequent hydration or hardening process. The void fraction in the building element, formed by the excess water that subsequently evaporates, results in significantly impaired mechanical strength, stability, and durability of adhesion.

In order to reduce this excess water fraction for a given working consistency and/or in order to improve the workability for a given water/binder ratio, admixtures are used which within the construction chemicals segment are generally referred to as water reducers or plasticizers. Known admixtures of this type include polycondensation products based on naphthalenesulfonic or alkylnaphthalenesulfonic acids, or melamine-formaldehyde resins comprising sulfonic acid groups.

Besides the purely anionic plasticizers, which comprise substantially carboxylic acid and sulfonic acid groups, a more recent group of plasticizers described are weakly anionic comb polymers, which customarily carry anionic charges in the main chain and comprise nonionic polyalkylene oxide side chains.

WO 01/96007 describes these weakly anionic plasticizers and grinding assistants for aqueous mineral suspensions, prepared by radical polymerization of monomers comprising vinyl groups, and comprising polyalkylene oxide groups as a principal component.

It has emerged that plasticizers based on lignosulfonate, melamine-sulfonate, and polynaphthylene-sulfonate are significantly inferior in their activity to the weakly anionic, polyalkylene oxide-comprising copolymers. These copolymers are also referred to as polycarboxylate ethers (PCEs). Polycarboxylate ethers not only disperse the inorganic particles via electrostatic charging, owing to the anionic groups (carboxylate groups, sulfonate groups) present on the main chain, but also, furthermore, stabilize the dispersed particles by means of steric effects, owing to the polyalkylene oxide side chains, which by absorbing water molecules form a stabilizing protective layer around the particles.

As a result it is either possible to reduce the required amount of water for the formulating of a particular consistency, as compared with the conventional plasticizers, or else the addition of the polycarboxylate ethers reduces the plasticity of the wet building-material mixture to such an extent that it is possible to produce self-compacting mortar with low water/binder ratios.

Dispersants based on polycarboxylate ethers and derivatives thereof are available either as solids in powder form or as aqueous solutions. Polycarboxylate ethers in powder form may be admixed, for example, to a factory dry-mix mortar in the course of its production. When the factory dry-mix mortar is mixed with water, the polycarboxylate ethers dissolve and are subsequently able to develop their effect.

Alternatively, it is also possible to add polycarboxylate ethers or derivatives thereof to the inorganic solids suspension in dissolved form. In particular the dispersant is metered directly into the mixing water.

In the case of highly flowable mixtures, however, there is a significant increase in the tendency for relatively heavy constituents (sand and possibly gravel) to segregate and for bleed water to separate off at the surface. This has adverse consequences for the workability and for the solid-state properties of the hardened building-material mixture. Accordingly, stabilizers (also referred to as antisegregation agents, antibleed agents, or viscosity modifiers) are employed in order to prevent these unwanted effects.

Water-soluble, nonionic derivatives of polysaccharides, especially cellulose derivatives and starch derivatives, are customarily used in aqueous building-material mixtures in order to prevent the unwanted evaporation of the water, which is needed for the hydration and workability, and also to control the segregation, sedimentation and bleeding (collecting of water on the surface) of the system.

According to Ullmann's Enzyklopadie der Technischen Chemie (4th edition, volume 9, pages 208-210, Verlag Chemie Weinheim), the most common rheological additives are synthetically produced nonionic cellulose derivatives and starch derivatives such as methylcellulose (MC), hydroxyethylcellulose (HEC), methylhydroxyethylcellulose (MHEC), and methylhydroxypropylcellulose (MHPC). Also used for regulating the rheology of aqueous building-material systems and coating systems in accordance with the prior art, however, are microbially generated polysaccharides such as welan gum, diutan gum, and naturally occurring polysaccharides (hydrocolloids) isolated by extraction, such as alginates, xanthans, carrageenans, galactomannans, etc.

There are many known classes of polymers, chemically different, which can be used as rheological additives in aqueous inorganic building-material mixtures. One important class of polymers with stabilizing activity is that known as hydrophobically associating polymers. This is the term the skilled person uses to refer to water-soluble polymers which pendently or terminally have hydrophobic groups, such as relatively long alkyl chains, for example. In aqueous solution, hydrophobic groups of this kind are able to associate with themselves or with other substances having hydrophobic groups. As a result of this, an associative network is formed that stabilizes the medium.

EP 705 854 A1, DE 100 37 629 A1, and DE 10 2004 032 304 A1 disclose water-soluble, hydrophobically associating copolymers and use thereof, in the construction chemistry sector, for example. The copolymers described comprise acid monomers such as, for example, acrylic acid, vinylsulfonic acid, acrylamidomethylpropanesulfonic acid, neutral monomers such as acrylamide, dimethylacrylamide, or monomers comprising cationic groups, such as monomers comprising ammonium groups, for example. Such monomers give the polymers the solubility in water. As hydrophobically associating monomers, the copolymers disclosed comprise in each case monomers of the following type: H₂C═C(R^{x})—COO—(—CH₂—CH₂—O—)_{q}—R^{y} or else H₂C═C(R^{x})—O—(—CH₂—CH₂—O—)_{q}—R^{y}, where R^{x} is typically H or CH₃ and R^{y} is a relatively large hydrocarbyl radical, typically hydrocarbyl radicals having 8 to 40 carbon atoms. Identified in the specifications are, for example, relatively long alkyl groups or else a tristyrylphenyl group.

Furthermore, U.S. Pat. No. 8,362,180 relates to water-soluble copolymers which comprise hydrophobically associating monomers. The monomers comprise an ethylenically unsaturated group and also a polyether group with block structure, composed of a hydrophilic polyalkylene oxide block, which consists essentially of ethylene oxide groups, and a terminal, hydrophobic polyalkylene oxide block, which consists of alkylene oxides having at least 4 carbon atoms, preferably at least 5 carbon atoms.

Also disclosed is the use of these hydrophobically associating copolymers in aqueous building-material compositions.

The hydrophobically associating copolymers known according to the prior art are very good stabilizers for aqueous inorganic building-material compositions. They have the disadvantage, however, that they impair the flowability of the aqueous inorganic building-material compositions.

It was an object of the present invention, accordingly, to provide additives for inorganic solids suspensions that during the application of the inorganic solids suspensions result in a high flowability of the system, with a high sedimentation resistance being achieved at the same time, especially in the state or rest of the system. The structural composition is, however, to be able to be destroyed again by low shearing load. This time-dependent and reversible process is referred to as thixotropy. In the present case, the thixotropy ought to be utilized specifically in order to stabilize inorganic suspensions.

This object has been achieved by means of a composition comprising
(α) at least one water-soluble polymer based on
   (a) 5 to 40 wt % of at least one monomer of the formula (I),

Z—R¹—O—(—CH₂—CH₂—O—)ₖ—(—CH₂—CH(R²)—O—)ₗ—(—CH₂—CH₂—O—)ₘ—R³ (I)
where the units —(—CH₂—CH₂—O—)ₖ, —(—CH₂—CH(R²)—O—)ₗ and —(—CH₂CH₂—O—)ₘ, where present, are arranged in block structure in the sequence shown in formula (I), and the radicals have the following definitions:
   Z: is an organic radical having at least one polymerizable structural group;
   k: is a number from 10 to 150;
   l: is a number from 1 to 25;
   m: is a number from 0 to 15;
   R¹: is independently at each occurrence a single bond or a divalent linking group selected from the group consisting of —(CₙH₂ₙ)— and —O—(C_{n′}H_{2n′})— and —C(O)—O—(C_{n″}H_{2n″})—, where n, n′ and n″ are a natural number from 1 to 6;
   R²: is a hydrocarbyl radical having at least 2 carbon atoms, or an ether group of the general formula —CH₂—O—R^{2′}, where R^{2′} is a hydrocarbyl radical having at least 2 carbon atoms and where R² within the group —(—CH₂—CH(R²)—O—)ₗ may be identical or different;
   R³: is independently at each occurrence H or a hydrocarbyl radical having 1 to 24 carbon atoms, and also
(b) 5 to 95 wt % of at least one polymerizable monomer (b), which is different from monomer (a) and comprises acid groups, and
(β) at least one associative thickener,

where the associative thickener (β) has an average molecular weight of 200 000 g/mol to 30 000 000 g/mol, as determined by the Mark-Houwink relationship (1),

M=([η]/K)^{1/n} (1)

where K=0.0049, α=0.8, └η┘ is the intrinsic viscosity, and M is the average molecular weight, and

the water-soluble polymer (a) has an average molecular weight of 5000 to 100 000 g/mol, as determined by gel permeation chromatography.

Surprisingly it has emerged here that the composition of the invention not only fully achieves the stated object but also, furthermore, can be used in relatively low dosages. In particular it is possible to reduce significantly the amount of associative thickener.

Details of the invention now follow.

It is essential to the invention that the polymerizable monomer (b) comprises an acid group. The term “acid group” in the present specification refers not only to the free acid but also to the salts thereof. The acid may preferably comprise at least one acid from the series consisting of carboxyl, phosphono, sulfino, sulfo, sulfamido, sulfoxy, sulfoalkyloxy, sulfinoalkyloxy, and phosphonooxy group. Particularly preferred are carboxyl and phosphonooxy groups.

In the monomers (a) of the general formula (I), Z is connected via a divalent linking group —R¹—O— to a polyalkyleneoxy radical with block structure —(—CH₂—CH₂—O—)ₖ—(—CH₂—CH(R²)—O—)ₗ—(—CH₂—CH₂—O—)ₘ R³, where the blocks —(—CH₂—CH₂—O—)ₖ, —(—CH₂—CH(R²)—O—)ₗ and —(—CH₂—CH₂—O—)ₘ, where present, are arranged in the sequence shown in formula (I). The monomer (a) has either a terminal OH group or a terminal ether group OR³.

R¹ is a single bond or a divalent linking group selected from the group consisting of —(CₙH₂ₙ)—, —O—(C_{n′}H_{2n′})— and —C(O)—O—(C_{n′}—H_{2n″})—. In the stated formulae, n, n′ and n″ are a natural number from 1 to 6. In other words, the linking group comprises straight-chain or branched aliphatic hydrocarbyl groups having 1 to 6 carbon atoms, which are linked either directly or via an ether group —O— or a carboxyl ester group —C(O)—O— to the group Z. Preferably the groups —(CₙH₂ₙ)—, —(C_{n′}H_{2n′})— and —(C_{n″}H_{2n″})— are linear aliphatic hydrocarbyl groups.

The group R¹═(CₙH₂ₙ)— is preferably a group selected from —CH₂—, —CH₂—CH₂— and —CH₂—CH₂—CH₂—, particular preference being given to a methylene group —CH₂—.

The group R¹=—O—(Cₙ₊H_{2n′})— is preferably a group selected from —O—CH₂—CH₂—, —O—CH₂—CH₂—CH₂— and —O—CH₂—CH₂—CH₂—CH₂—, particular preference being given to —O—CH₂—CH₂—CH₂—CH₂—.

The group R¹═—C(O)—O—(C_{n″}H_{2n″})— is preferably a group selected from —C(O)—O—CH₂—, —C(O)—O—CH₂—CH₂— and —C(O)—O—CH₂—CH₂—CH₂—, particular preference being given to —C(O)—O—CH₂—CH₂-—.

Especially preferably the group R¹ is a group —O—(C_{n′}H_{2n′})—.

Additionally, more preferably, R¹ is a group selected from —CH₂— or —O—CH₂—CH₂—CH₂—CH₂— or —C(O)—O—CH₂—CH₂—, very particular preference being given to —O—CH₂—CH₂—CH₂—CH₂—.

The monomers (a) additionally have a polyalkyleneoxy radical which consists of the units —(—CH₂—CH₂—O—)ₖ, —(—CH₂—CH(R²)—O—)ₗ and —(—CH₂—CH₂—O—)ₘ, where the units in block structure are arranged in the sequence shown in formula (I). The transition between the blocks may be abrupt or else continuous.

The number of ethyleneoxy units k is a number from 10 to 150, preferably from 12 to 50, especially preferably from 15 to 35, and more preferably from 20 to 30.

The number of ethyleneoxy units k is very preferably a number from 23 to 26. The stated numbers are always averages of distributions.

In the case of the second block —(—CH₂—CH(R²)—O—)ₗ—, the radicals R² independently of one another are hydrocarbyl radicals having at least 2 carbon atoms, preferably having 2 to 20 carbon atoms, especially preferably having 2 to 4 and more preferably having 2 or 3 carbon atoms. This may be an aliphatic and/or aromatic, linear or branched hydrocarbyl radical. Aliphatic radicals are preferred. Particularly preferred is an aliphatic, unbranched hydrocarbyl radical having 2 or 3 carbon atoms. The stated block is preferably a polybutyleneoxy block or a polypentyleneoxy block.

Examples of suitable radicals R² comprise ethyl, n-propyl, n-butyl, n-pentyl, n-hexyl, n-heptyl, n-octyl, n-nonyl or n-decyl, n-dodecyl, n-tetradecyl, and phenyl.

Examples of suitable radicals R² comprise ethyl, n-propyl, n-butyl, n-pentyl, n-hexyl, n-heptyl, n-octyl, n-nonyl or n-decyl, and phenyl. Examples of preferred radicals comprise n-propyl, n-butyl, n-pentyl; particularly preferred is an ethyl radical or an n-propyl radical.

The radicals R² may additionally be ether groups of the general formula —CH₂—O—R^{2′}, where R^{2′} is an aliphatic and/or aromatic, linear or branched hydrocarbyl radical having at least 2 carbon atoms, preferably 2 to 10 carbon atoms, and more preferably at least 3 carbon atoms.

Examples of radicals R^{2′} comprise n-propyl, n-butyl, n-pentyl, n-hexyl, 2-ethylhexyl, n-heptyl, n-octyl, n-nonyl, n-decyl or phenyl.

Examples of radicals R^{2′} comprise n-propyl, n-butyl, n-pentyl, n-hexyl, 2-ethylhexyl, n-heptyl, n-octyl, n-nonyl, n-decyl, n-dodecyl, n-tetradecyl or phenyl.

The block —(—CH₂—CH(R²)—O—)ₗ— is therefore a block which consists of alkyleneoxy units having at least 4 carbon atoms, preferably having 4 or 5 carbon atoms, and/or glycidyl ethers having an ether group of at least 2, preferably at least 3, carbon atoms. Preferred as radicals R² are the stated hydrocarbyl radicals; the structural units of the second block are more preferably alkyleneoxy units comprising at least 4 carbon atoms, such as butyleneoxy and pentyleneoxy units, or units of higher alkylene oxides, very preferably butylene oxide or pentyleneoxy units.

In an additionally preferred embodiment, the radicals R² independently of one another are hydrocarbyl radicals having at least 6 carbon atoms, preferably having 6 to 20 carbon atoms, especially preferably having 8 to 18 and more preferably having 8 to 16 carbon atoms. The radical in question may be an aliphatic and/or aromatic, linear or branched hydrocarbyl radical. Aliphatic radicals are preferred. More preferably it is an aliphatic, unbranched hydrocarbyl radical having 10, 12, 14 or 16 carbon atoms.

In particular the radicals R² independently of one another are hydrocarbyl radicals having at least 6 carbon atoms if I assumes a number from 1 to 12.

For the skilled person in the field of polyalkylene oxides it is clear that the orientation of the hydrocarbyl radicals R² may be dependent on the alkoxylation conditions, as for example on the catalyst selected for the alkoxylation. The alkyleneoxy groups may therefore be incorporated into the monomer either in the orientation —(—CH₂CH(R²)—O—)— or else in the inverse orientation —(—CH(R²)—CH₂—O—)—. The representation in formula (I) is therefore not to be considered as restricted to a particular orientation of the group R².

The number of alkyleneoxy units I is a number from 1 to 25, more particularly from 1 to 23, more preferably from 7 to 20, very preferably from 12 to 17.25.

The sum of the carbon atoms in all hydrocarbyl radicals R² within the group —(—CH₂—CH(R²)—O—)ₗ preferably is from 10 to 50, preferably from 12 to 40, especially preferably from 25.5 to 34.5. Where the radicals R² are an ether group —CH₂—O—R^{2′}, the proviso is that the sum of the hydrocarbyl radicals of R^{2′} within the group —(—CH₂—CH(R^{2′})—O—)ₗ is from 10 to 50, preferably from 12 to 40, especially preferably from 25.5 to 34.5, disregarding the carbon atom of the linking —CH₂—O— group in —CH₂—O—R^{2′}.

One preferred embodiment relates to an above-described water-soluble polymer comprising a monomer (a), where R² is ethyl and I is a number from 12 to 25, preferably from 14 to 25, especially preferably from 14 to 23, as for example 14, 16, 18 or 22.

The number of alkyleneoxy units I in one preferred embodiment is a number from 12 to 20, in particular subject to the proviso that the sum of the carbon atoms in all hydrocarbyl radicals R² is in the range from 30 to 45. Where the radicals R² are an ether group —CH₂—O—R^{2′}, the proviso in particular is that the sum of the hydrocarbyl radicals R^{2′} is in the range from 30 to 45, disregarding the carbon atom of the linking —CH₂—O group in —CH₂—O—R^{2′}. One preferred embodiment relates to an above-described water-soluble polymer comprising a monomer (a), where R² is ethyl and I is a number from 14 to 20, more particularly from 14 to 18, as for example 14 or 16. Another preferred embodiment relates to an above-described water-soluble polymer comprising a monomer (a), where R² is n-propyl and I is a number from 8.5 to 11.5, preferably from 9 to 11, as for example 10 or 11. As already mentioned, the stated numbers are averages of distributions.

The block —(—CH₂—CH₂—O—)ₘ is a polyethyleneoxy block. The number of ethyleneoxy units m is a number from 0 to 15, preferably from 0.1 to 10, more preferably from 0.1 to 5, especially preferably from 0.5 to 5, and very preferably from 2 to 5. Again the stated numbers are averages of distributions.

The radical R³ is H or a preferably aliphatic hydrocarbyl radical having 1 to 24 carbon atoms. R³ is preferably H, methyl or ethyl, more preferably H or methyl, and very preferably H.

For the skilled person in the field of polyalkyleneoxy block copolymers it is clear that the transition between the blocks, where present, may be abrupt or else continuous, depending on the nature of production. In the case of a continuous transition, there is additionally located, between the blocks, a transition zone which comprises monomers of both blocks. If the block boundary is specified at the middle of the transition zone, accordingly, the first block —(—CH₂—CH₂—O—)ₖ may also comprise small amounts of units —(—CH₂—CH(R²)—O—)—, and the second block —(—CH₂—CH(R²)—O—)ₗ may comprise small amounts of units —(—CH₂—CH₂—O—)—, although these units are not distributed statistically over the block but are instead arranged in the stated transition zone. In particular, the third block (—CH₂—CH₂—O—)ₘ may comprise small amounts of units —(—CH₂—CH(R²)—O—)—.

Block structure in the sense of the present invention means that the blocks are constructed to an extent of at least 85 mol %, preferably at least 90 mol %, more preferably at least 95 mol %, based on the total amount of substance of the respective block, of the corresponding units. This means that the blocks, in addition to the corresponding units, may comprise small amounts of other units (in particular, other polyalkyleneoxy units). In particular, the polyethyleneoxy block —(—CH₂—CH₂—O—)ₘ comprises at least 85 mol %, preferably at least 90 mol %, based on the total amount of substance of the block, of the unit (—CH₂—CH₂—O—). With particular preference, the polyethyleneoxy block —(—CH₂—CH₂—O—)ₘ consists of 85 to 95 mol % of the unit (—CH₂—CH₂—O—) and of 5 to 15 mol % of the unit —(—CH₂—CH(R²)—O—).

The invention relates more preferably to a polymer (a) in which the radicals in monomer (a) of formula (I) have the following definitions:
k: is a number from 20 to 150
l: is a number from 1 to 25
m: is a number from 0 to 15
R¹: is independently at each occurrence a single bond or a divalent linking group selected from the group consisting of —(CₙH₂ₙ)— and —O—(C_{n′}H_{2n′})— and —C(O)—O—(C_{n″}H_{2n″})—, where n, n′ and n″ are a natural number from 1 to 6;
R²: is a hydrocarbyl radical having at least 2 carbon atoms, or an ether group of the general formula —CH₂—O—R^{2′}, where R^{2′} is a hydrocarbyl radical having at least 2 carbon atoms and where R² within the group —(—CH₂—CH(R²)—O—)ₗ may be identical or different;
R³: is independently at each occurrence H or a hydrocarbyl radical having 1 to 4 carbon atoms.

The invention relates preferably to a polymer (a) in which the radicals in monomer (a) of formula (l) have the following definitions:
k: is a number from 15 to 35, preferably from 20 to 28, more particularly from 23 to 26;
l: is a number from 14 to 25, preferably from 14 to 23, more particularly from 14 to 20;
m: is a number from 0 to 15, preferably from 0.5 to 10;
R¹: is a divalent linking group —O—(C_{n′}H_{2n′})—, where n′ is 4;
R²: is a hydrocarbyl radical having 2 carbon atoms; more particularly ethyl;
R³: is H.

The invention relates additionally preferably to a polymer (a) in which the radicals in monomer (a) of formula (I) have the following definitions:
k: is a number from 15 to 35, preferably from 20 to 28, more preferably from 23 to 26;
l: is a number from 1 to 14, preferably from 1 to 12, more preferably from 1 to 10, as for example 1, 2 or 3;
m: is a number from 0 to 15, preferably from 0.5 to 10;
R¹: is a divalent linking group —O—(C_{n′}H_{2n′})— where n′ is 4;
R²: is independently at each occurrence a hydrocarbyl radical having 8 to 20 carbon atoms;
R³: is H.

The invention relates preferably to a polymer (a) in which the radicals in monomer (a) of formula (I) have the following definitions:
k: is a number from 15 to 35, preferably from 20 to 28, preferably from 23 to 26;
l: is a number from 14 to 25, preferably from 16 to 25, more preferably from 18 to 25; especially preferably from 18 to 23, as for example 14, 16 or 22;
m: is a number from 0.1 to 10, preferably from 0.5 to 10, especially preferably from 2 to 5;
R¹: is a divalent linking group —O—(C_{n′}H_{2n′})— where n′ is 4;
R²: is independently at each occurrence a hydrocarbyl radical having at least 2 carbon atoms; more particularly ethyl;
R³: is H.

The invention relates especially preferably to a polymer (a) in which the radicals in monomer (a) of formula (I) have the following definitions:
k: is a number from 23 to 26;
l: is a number from 14 to 22;
m: is a number from 0 to 15; preferably from 0.5 to 10;
R²: is independently at each occurrence a hydrocarbyl radical having at least 2 carbon atoms; more particularly ethyl;
R³: is H.

Additionally the invention relates in particular to a polymer (a) in which the radicals in monomer (a) of formula (I) have the following definitions:
k: is a number from 23 to 26;
l: is a number from 10 to 18;
m: is a number from 0 to 15, preferably from 0.5 to 10;
R¹: is a divalent linking group —O—(C_{n′}H_{2n′})— where n′ is 4;
R²: is a hydrocarbyl radical having 3 carbon atoms, more particularly n-propyl;
R³: is H.

In one particularly preferred embodiment, the invention relates to a polymer (α) in which the radicals in monomer (a) of formula (I) have the following definitions:
k: is a number from 23 to 26;
l: is a number from 14 to 18;
m: is a number from 2 to 5;
R¹: is a divalent linking group —O—(C_{n′}H_{2n′})— where n′ is 4;
R²: is a hydrocarbyl radical having 2 carbon atoms;
R³: is H.

In an additionally particularly preferred embodiment, the invention relates to a polymer (α) in which the radicals in monomer (a) of formula (I) have the following definitions:
k: is a number from 10 to 150
l: is a number from 1 to 2
m: is 0
R¹: is independently at each occurrence a single bond or a divalent linking group selected from the group consisting of —(CₙH₂ₙ)— and —O—(C_{n′}H_{2n′})— and —C(O)—O—(C_{n″}H_{2n″})—, where n, n′ and n″ are a natural number from 1 to 6;
R²: is a hydrocarbyl radical having 8 to 24 carbon atoms;
R³: is H.

In one preferred embodiment, the invention relates to polymers (α) of the invention in which the radical k in monomer (a) of formula (I) is a number from 23 to 26.

In an additionally preferred embodiment, the invention relates to polymers (α) of the invention in which the radical I in monomer (a) of formula (I) is a number from 14 to 25.

The polymer (α) of the invention is a water-soluble polymer which has hydrophobic groups. In aqueous compositions it is possible, without being bound by this theory, for the hydrophobic groups to associate with themselves or with the hydrophobic groups of other substances, especially of the at least one associative thickener, and through these interactions they thicken the aqueous composition.

The skilled person is aware that the solubility of hydrophobically associating polymers in water may be more or less heavily dependent on the pH, depending on the nature of the monomers used.

“Water-soluble polymer” for the purposes of the present specification comprehends polymers which in water at 20° C. under atmospheric pressure and at least a pH from the series 2, 7 or 12 have a solubility of at least 1 gram per liter of water, more particularly at least 10 grams per liter of water, and very preferably of at least 100 grams per liter of water.

In one particularly preferred embodiment, the at least one water-soluble polymer (α) is a polycondensation product based on
(a) at least one monomer of the formula (I), where Z is an aromatic or heteroaromatic and
(b) where the monomer (b) is phosphated or sulfonated and has an aromatic or heteroaromatic as polymerizable group.

In one particularly preferred embodiment, Z in formula (I) is identical or different and is represented by a substituted or unsubstituted, aromatic or heteroaromatic compound having 5 to 10 carbon atoms in the aromatic system, and (b) is represented by the following general formula (II)

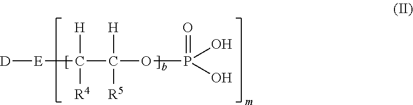

where

D is identical or different and is represented by a substituted or unsubstituted, aromatic or heteroaromatic compound having 5 to 10 carbon atoms in the aromatic system.

Furthermore, E is identical or different and is represented by N, NH or O; m=2 if E=N and m=1 if E=NH or O.

R⁴ and R⁵ are independently of one another identical or different and are represented by a branched or unbranched C₁ to C₁₀ alkyl radical, C₅ to C₈ cycloalkyl radical, aryl radical, heteroaryl radical or H, preferably by H, methyl, ethyl or phenyl, more preferably by H or methyl, and especially preferably by H. Additionally, b is identical or different and is represented by an integer from 0 to 300. If b=0, E=O. With particular preference D=phenyl, E=O, R⁴ and R⁵═H, and b=1.

The water-soluble polymer (α) is preferably a polycondensation product which comprises a structural unit (III) which is represented by the following formula

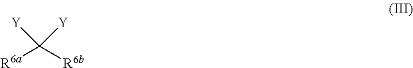

where

R^{6a} and R^{6b} independently of one another are identical or different and are represented by H, CH₃, COOH or a substituted or unsubstituted, aromatic or heteroaromatic compound having 5 to 10 carbon atoms, preferably H, COOH and/or methyl, and

Y independently at each occurrence is identical or different and is represented by structural units which correspond to formula (I) and formula (II) of the polycondensation product, or other constituents of the polycondensation product.

The molar ratio of the polymerized monomers (I) and (II) and also of the structural unit (III) in the phosphated polycondensation product of the invention may be varied within wide ranges. It has proven useful if the molar ratio of [(I)+(II)]:(III) is 1:0.8 to 3, preferably 1:0.9 to 2, and more preferably 1:0.95 to 1.2.

The groups Z and D in the monomers (I) and (II) are usually represented by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, preferably phenyl, where Z and D may be selected independently of one another and may also each consist of a mixture of the stated compounds. The group E is preferably represented by 0.

Preferably, in monomer (II), b is represented by an integer from 0 to 10, preferably 1 to 7, and more preferably 1 to 5. The respective radicals whose length is defined by b may consist here of unitary structural groups; however, it may also be useful for them to be a mixture of different structural groups. Furthermore, the radical of the monomer (II) may possess the same chain length in each case, with b being represented in each case by a number. In general, however, it will be useful for mixtures with different chain lengths to be present in each case, so that b has different numerical values.

In one particular embodiment, additionally, the present invention provides for the salt of the phosphated polycondensation product of the invention to be a sodium, potassium, ammonium and/or calcium salt, and preferably a sodium and/or potassium salt.

With regard to the phosphated polycondensation products for preferred use in accordance with the present invention, and to their preparation, reference is additionally made to patent applications WO 2006/042709 and WO 2010/040612, whose content is hereby incorporated into the specification. The phosphated polycondensation product of the invention may be prepared in analogy to the process described in example 2 on page 13 of WO 2010/040612, it being necessary merely to replace the poly(ethylene oxide) monophenyl ether monomer by a monomer of the formula (I) of the present invention.

In another preferred embodiment, the water-soluble polymer (a) comprises at least one copolymer based on
(a) at least one monomer of the formula (I), where Z is an ethylenically unsaturated radical and
(b) where the monomer (b) has at least one ethylenically unsaturated radical.

In an additionally preferred embodiment, the ethylenically unsaturated monomer (b) is represented by at least one of the following general formulae from the group consisting of (IV), (V), and (VI):

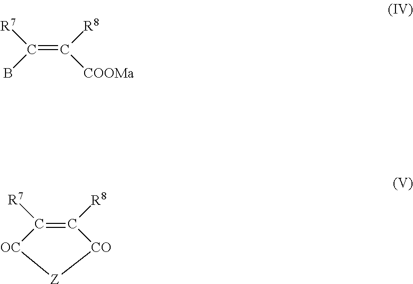

In the case of the monocarboxylic or dicarboxylic acid derivative (IV) and the monomer (V) present in cyclic form, where Z═O (acid anhydride) or NR¹⁶ (acid imide), R⁷ and R⁸ independently of one another are hydrogen or an aliphatic hydrocarbyl radical having 1 to 20 carbon atoms, preferably a methyl group. B is H, —COOMₐ, —CO—O(C_{q}H_{2q}O)ᵣ—R⁹, —CO—NH—(C_{q}H_{2q}O)ᵣ—R⁹.

M is hydrogen, a mono-, di- or trivalent metal cation, preferably sodium, potassium, calcium or magnesium ion, additionally ammonium or an organic amine radical, and a=⅓, ½ or 1, depending on whether M is a mono-, di- or trivalent cation. Organic amine radicals used are preferably substituted ammonium groups which derive from primary, secondary or tertiary C₁₋₂₀ alkylamines, C₁₋₂₀ alkanolamines, C₅₋₈ cycloalkylamines, and C₆₋₁₄ arylamines. Examples of the corresponding amines are methylamine, dimethylamine, trimethylamine, ethanolamine, diethanolamine, triethanolamine, methyldiethanolamine, cyclohexylamine, dicyclohexylamine, phenylamine, diphenylamine in the protonated (ammonium) form.

R⁹ is hydrogen, an aliphatic hydrocarbyl radical having 1 to 20 carbon atoms, a cycloaliphatic hydrocarbyl radical having 5 to 8 carbon atoms, an aryl radical having 6 to 14 carbon atoms, it additionally being possible optionally for this radical to be substituted, q=2, 3 or 4, and r=0 to 200, preferably 1 to 150. The aliphatic hydrocarbons here may be linear or branched and also saturated or unsaturated. Preferred cycloalkyl radicals are cyclopentyl or cyclohexyl radicals, phenyl or naphthyl radicalsare to be regarded as preferred aryl radicals, which may additionally in particular be substituted by hydroxyl, carboxyl or sulfonic acid groups.

Additionally, Z is O or NR¹⁶, where R¹⁶ independently at each occurrence is identical or different and is represented by a branched or unbranched C₁ to C₁₀ alkyl radical, C₅ to C₈ cycloalkyl radical, aryl radical, heteroaryl radical or H.

The following formula is the monomer (Vc):

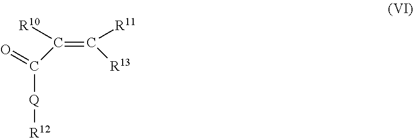

In this case, R¹⁰ and R¹¹ independently of one another are hydrogen or an aliphatic hydrocarbyl radical having 1 to 20 carbon atoms, a cycloaliphatic hydrocarbyl radical having 5 to 8 carbon atoms, an optionally substituted aryl radical having 6 to 14 carbon atoms.

Additionally, R¹² is identical or different and is represented by (CₙH₂ₙ)—SO₃H with n=0, 1, 2, 3 or 4, (CₙH₂ₙ)—OH with n=0, 1, 2, 3 or 4; (CₙH₂ₙ)—PO₃H₂ with n=0, 1, 2, 3 or 4, (CₙH₂ₙ)—OPO₃H₂ with n=0, 1, 2, 3 or 4, (C₆H₄)—SO₃H, (C₆H₄)—PO₃H₂, (C₆H₄)—OPO₃H₂ and (CₙH₂ₙ)—NR¹⁴_{b} with n=0, 1, 2, 3 or 4 and b is represented by 2 or 3.

R¹³ is H, —COOMₐ, —CO—O(C_{q}H_{2q}O)ᵣ—R⁹, —CO—NH—(C_{q}H₂ₐO)ᵣ—R⁹, where Mₐ, R⁹, q and r possess the definitions stated above.

R¹⁴ is hydrogen, an aliphatic hydrocarbyl radical having 1 to 10 carbon atoms, a cycloaliphatic hydrocarbyl radical having 5 to 8 carbon atoms, an optionally substituted aryl radical having 6 to 14 carbon atoms.

Additionally, Q is identical or different and is represented by NH, NR¹⁵ or O, where R¹⁵ is an aliphatic hydrocarbyl radical having 1 to 10 carbon atoms, a cycloaliphatic hydrocarbyl radical having 5 to 8 carbon atoms, or an optionally substituted aryl radical having 6 to 14 carbon atoms.

Examples of suitable monomers (b) are, in particular, monomers comprising —COOH groups such as acrylic acid or methacrylic acid, crotonic acid, itaconic acid, maleic acid or fumaric acid, monomers comprising sulfonic acid groups such as vinylsulfonic acid, allylsulfonic acid, sulfoethyl methacrylate, 2-acrylamido-2-methylpropanesulfonic acid (AMPS), 2-methacrylamido-2-methylpropanesulfonic acid, 2-acrylamidobutanesulfonic acid, 3-acrylamido-3-methyl-butanesulfonic acid or 2-acrylamido-2,4,4-trimethylpentanesulfonic acid, or monomers comprising phosphonic acid groups such as vinylphosphonic acid, allylphosphonic acid, N-(meth)acrylamidoalkylphosphonic acids or (meth)acryloyloxyalkylphosphonic acids.

In one particularly preferred embodiment, Z in formula (I) is represented by at least one radical of the formula (VII)

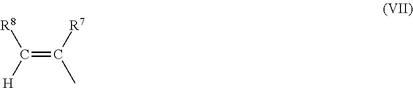

in which

R⁷ and R⁸ have the definitions stated above.

The water-soluble polymers (a) in accordance with the present invention comprise at least two monomer units. In one preferred embodiment, the overall sum of the monomers (a) and (b) in the polymer (a) of the invention is 100 wt %.

It may, however, also be advantageous to use polymers having three or more monomer units.

In an additionally preferred embodiment, therefore, as well as the monomer units (a) and (b), the water-soluble polymer (a) additionally comprises from 5 to 90 wt %, preferably 30 to 90 wt %, especially preferably 50 to 80 wt %, of at least one further monomer unit.

In particular the further monomer units of the water-soluble polymer (α) may optionally comprise at least one compound of the formula (Ia):

Z—R^{1a}—O—(—CH₂—CH₂—O—)ₖₐ—R^{2a} (Ia)

where the radicals have the following definitions:
Z: is an organic radical having at least one polymerizable structural group;
ka: is a number from 10 to 300;
R^{1a}: is independently at each occurrence a single bond or a divalent linking group selected from the group consisting of —(CₙH₂ₙ)— and —O—(C_{n′}H_{2n″})— and —C(O)—O—(C_{n″}H_{2n″})—, where n, n′ and n″ are a natural number from 1 to 6;
R^{2a}: is independently at each occurrence H or a hydrocarbyl radical having 1 to 4 carbon atoms.

Especially preferably the radicals of the monomer unit of formula (Ia) have the following definitions:
Z: is an ethylenically unsaturated radical, more particularly a radical of the formula (VII) and especially preferably vinyl;
ka: is a number from 10 to 150, especially 12 to 75 and more preferably 15 to 45;
R^{1a}: is independently at each occurrence a divalent linking group selected from the group consisting of —O—(C_{n′}H_{2n′})— and —C(O)—O—(C_{n″}H_{2n″})—, where n′ and n″ are a natural number from 1 to 4; with particular preference, it is —O—(C_{n′}H_{2n′})— with n′ being 4;
R^{2a}: is independently at each occurrence H or a hydrocarbyl radical having 1 to 4 carbon atoms, especially preferably H or a methyl radical.

A suitable solvent in the preparation of the copolymers (a) of the invention which have ethylenic radicals as polymerizable group is water in particular. It is, however, also possible to use a mixture of water and an organic solvent, in which case the solvent ought to be very largely inert with respect to radical polymerization reactions. In particular the organic solvent may comprise at least one solvent from the series consisting of ethyl acetate, n-butyl acetate, 1-methoxy-2-propyl acetate, ethanol, isopropanol, n-butanol, 2-ethyihexanol, 1-methoxy-2-propanol, ethylene glycol, propylene glycol, acetone, butanone, pentanone, hexanone, methyl ethyl ketone, ethyl acetate, butyl acetate, amyl acetate, tetrahydrofuran, diethyl ether, toluene, xylene or higher-boiling alkylbenzenes. It may additionally comprise polyethylene glycol ethers or polypropylene glycol ethers or random ethylene oxide/propylene oxide copolymers having an average molar mass of 200 to 2000 g/mol, mono-, di- or triethylene glycol, mono-, di- or tripropylene glycol, methyl, ethyl, propyl, butyl or higher alkyl polyalkylene glycol ethers having 1, 2, 3 or more ethylene glycol and/or propylene glycol units, examples being methoxypropanol, dipropylene glycol monomethyl ether, tripropylene glycol monomethyl ether, ethylene glycol monobutyl ether, diethylene glycol monobutyl ether, butyl polyethylene glycol ether, propyl polyethylene glycol ether, ethyl polyethylene glycol ether, methyl polyethylene glycol ether, dimethyl polyethylene glycol ether, dimethyl polypropylene glycol ether, glycerol ethoxylates having a molecular weight of 150 to 20 000 g/mol, pentaerythritol alkoxylates, ethylene carbonate, propylene carbonate, glycerol carbonate, glycerol formal, and 2,3-O-isopropylideneglycerol. Especially preferred are alkyl polyalkylene glycol ethers and more preferably methyl polyethylene glycol ethers and also polyethylene glycol ethers, polypropylene glycol ethers and random ethylene oxide/propylene oxide copolymers having an average molar mass of 150 to 2000 g/mol. Additionally preferred are solvents based on carbonates, especially ethylene carbonate, propylene carbonate, and glycerol carbonate.

The polymerization reaction takes place preferably in the temperature range between 0 and 180° C., more preferably between 10 and 100° C., either under atmospheric pressure or else under elevated or reduced pressure. The polymerization may optionally also be performed under an inert gas atmosphere, preferably under nitrogen.

For initiating the polymerization it is possible for high-energy electromagnetic radiation, mechanical energy or chemical polymerization initiators such as organic peroxides, e.g. benzoyl peroxide, tert-butyl hydroperoxide, methyl ethyl ketone peroxide, cumoyl peroxide, dilauroyl peroxide or azo initiators, such as azodiisobutyronitrile, azobisamidopropyl hydrochloride, and 2,2′-azobis(2-methylbutyronitrile), for example, to be used. Likewise suitable are inorganic peroxy compounds, such as ammonium peroxodisulfate, potassium peroxodisulfate or hydrogen peroxide, for example, optionally in combination with reducing agents (e.g., sodium hydrogensulfite, ascorbic acid, iron(II) sulfate) or redox systems which as their reducing component comprise an aliphatic or aromatic sulfonic acid (e.g. benzenesulfonic acid, toluenesulfonic acid).

Especially preferred is a mixture of at least one sulfinic acid with at least one iron(III) salt and/or a mixture of ascorbic acid with at least one iron(III) salt.

Chain transfer agents (CTAs) for regulating molecular weight that are used are the customary compounds. Suitable known CTAs are, for example, alcohols, such as methanol, ethanol, propanol, isopropanol, n-butanol, sec-butanol, and amyl alcohols, aldehydes, ketones, alkylthiols, such as dodecyithiol and tert-dodecylthiol, for example, thioglycolic acid, isooctyl thioglycolate, 2-mercaptoethanol, 2-mercaptopropionic acid, 3-mercaptopropionic acid, and certain halogen compounds, such as carbon tetrachloride, chloroform and methylene chloride, for example, and also sodium hypophosphite and formic acid.

In an alternative further embodiment, the process for preparing the copolymers of the invention may also be carried out in an organic solvent or in a mixture of two or more organic solvents. Considered particularly suitable for this purpose in particular are, again, the organic solvents already stated earlier on above.

The average molecular weight M_{w} of the water-soluble polymer (α) of the invention, as determined by gel permeation chromatography (GPC), is 5000 to 100 000 g/mol, more preferably 7000 to 75 000 g/mol, and very preferably 10 000 to 45 000 g/mol. The polymers were analyzed for the average molecular weight M_{w} by means of size exclusion chromatography. Column combinations: Shodex OHpak SB 804HQ from Showa, Japan (polyhydroxymethacrylate gel, particle size 10 μm, pore size 2000 Å, plate number>16 000, column diameter and length 8 mm×300 mm) and Shodex OHpak 802.5HQ from Showa, Japan (polyhydroxymethacrylate gel, particle size 6 μm, pore size 200 Å, plate number>16 000, column diameter and length 8 mm×300 mm); eluent: 0.05 M ammonium formate/methanol (80/20 vol %), pH 6.5; flow rate: 0.5 ml/min; column temperature: 50° C.; detection: RI; calibration: PEG/PEO standards in the 10e6-10e2 g/mol range.

The polymer of the invention preferably meets the requirements of industrial standard EN 934-2 (February 2002).

A further subject of the present specification is a process for preparing the monomer (a) of the general formula (I) by a process comprising the following steps:
a) reacting an alcohol A1 of the general formula (A1)

Z—R¹—OH (A1),
with ethylene oxide,
where the radical R¹ has the meanings defined above;
with addition of an alkaline catalyst K1 comprising KOMe and/or NaOMe;
to give an alkoxylated alcohol A2;
b) reacting the alkoxylated alcohol A2 with at least one alkylene oxide C of the formula (C)

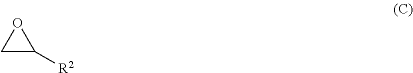

where R² has the meaning defined above;
with addition of an alkaline catalyst K2;
where the concentration of potassium ions during the reaction in step b) is less than or equal to 0.9 mol %, based on the alcohol A2 used;
and where the reaction in step b) is carried out at a temperature of less than or equal to 135° C.,
to give an alkoxylated alcohol A3 of the formula (A3),

Z—R¹—O—(—CH₂—CH₂—O—)ₖ—(—CH₂—CH(R²)—O—)ₗ—H (A3)
where the radicals R¹, R², k, and l have the meanings defined above;
c) optionally reacting the alcohol A3 with ethylene oxide; to give an alkoxylated alcohol A4 which corresponds to the monomer (a) of formula (I) with R³═H and m=1 to 15;
d) optionally etherifying the alkoxylated alcohol A4 with a compoud

R³—X
where R³ is a hydrocarbyl radical having 1 to 24 carbon atoms and X is a leaving group preferably selected from the group consisting of Cl, Br, I, —O—SO₂—CH₃ (mesylate) and —O—SO₂—CF₃ (triflate);
to give a monomer (a) of formula (I) with R³=hydrocarbyl radical having 1 to 24 carbon atoms.

In one preferred embodiment, the at least one associative thickener (β) of the invention comprises at least one water-soluble copolymer based on
(c) 0.1 to 35 wt %, more particularly 0.1 to 20 wt %, of at least one monomer of the formula (VIII),

H₂C═C(R¹⁷)—R¹—O—(—CH₂—CH₂—O—)ₖ—(—CH₂—CH(R²)—O—)ₗ—(—CH₂—CH₂—O—)ₘ—R³ (VIII)

where the units —(—CH₂—CH₂—O—)ₖ, —(—CH₂—CH(R²)—O—)ₗ and —(—CH₂—CH₂—O—)ₘ, where present, are arranged in block structure in the sequence shown in formula (VIII), and where R¹⁷ is H or methyl and the remaining radicals have the definitions stated in formula (I), and
(d) 10 to 99.9 wt %, more particularly 25 to 99.9 wt %, of at least one hydrophilic monomer (d) which is different from monomer (c).

In one particularly preferred embodiment, the radicals of the monomer of the formula (VIII) have the following definition:
k is a number from 10 to 150;
l is a number from 1 to 25;
m is a number from 0 to 15;
R¹: is independently at each occurrence a single bond or a divalent linking group selected from the group consisting of —(CₙH₂ₙ)— and —O—(C_{n′}H_{2n′})— and —C(O)—O—(C_{n″}H_{2n″})—, where n, n′ and n″ are a natural number from 1 to 6;
R²: is a hydrocarbyl radical having at least 2 carbon atoms, or an ether group of the general formula —CH₂—O—R^{2′}, where R^{2′} is a hydrocarbyl radical having at least 2 carbon atoms and where R² within the group —(—CH₂—CH(R²)—O—)ₗ may be identical or different;
R³: is independently at each occurrence H or a hydrocarbyl radical having 1 to 24 carbon atoms.

In one preferred embodiment, the radicals of the monomer of the formula (VIII) have the following definition:
k: is a number from 23 to 26;
l: is a number from 14 to 20;
m: is a number from 2 to 5;
R¹: is a divalent linking group —O—(C_{n′}H_{2n′})— where n′ is 4,
R²: is a hydrocarbyl radical having 2 carbon atoms;
R³: is H
R¹⁷: is H.

In one preferred embodiment, the preparation of the associative thickeners (β) is undertaken by means of gel polymerization in aqueous phase, provided that all of the monomers used have sufficient solubility in water. For the purposes of the present invention, a gel polymerization constitutes a special case of solution polymerization, and is therefore encompassed by that term. For the gel polymerization, first of all a mixtue of the monomers, initiators, and other auxiliaries with water or an aqueous solvent mixture is provided. Suitable aqueous solvent mixtures comprise water and also water-miscible organic solvents, the water fraction generally being at least 50 wt %, preferably at least 80 wt %, and more preferably at least 90 wt %. Organic solvents to be mentioned in this context are, in particular, water-miscible alcohols such as methanol, ethanol or propanol. Acidic monomers may be wholly or partly neutralized prior to the polymerization.

The concentration of all the components apart from the solvents is customarily 25 to 60 wt %, preferably 30 to 50 wt %.

The mixture is subsequently polymerized photochemically and/or thermally, preferably at −5° C. to 50° C. Where polymerization takes place thermally, preference is given to using polymerization initiators which initiate even at comparatively low temperature, such as redox initiators for example. The thermal polymerization may be performed even at room temperature or by heating of the mixture, preferably to temperatures of not more than 50° C. The photochemical polymerization is customarily performed at temperatures of −5 to 10° C. With particular advantage, photochemical and thermal polymerization can be combined with one another by adding not only initiators of thermal polymerization but also initiators of photochemical polymerization to the mixture. The polymerization in this case is first initiated photochemically at low temperatures, preferably −5 to +10° C. The heat of reaction that is released causes the mixture to warm up, thereby additionally initiating the thermal polymerization. By means of this combination it is possible to achieve a conversion of more than 99%.

The gel polymerization takes place as a general rule without stirring. It may take place batchwise, with the mixture being irradiated and/or heated in a suitable vessel at a layer thickness of 2 to 20 cm. The polymerization causes a solid gel to form. The polymerization may also take place continuously. For this purpose a polymerization apparatus is utilized which has a conveyor belt for accommodating the mixture to be polymerized. The conveyor belt is equipped with apparatus for heating or for irradiating with UV radiation. Thereafter the mixture is poured on at one end of the belt, by means of a suitable apparatus; in the course of transport in belt direction, the mixture undergoes polymerization, and the solid gel can be taken off at the other end of the belt.

Following the polymerization, the gel is comminuted and dried. Drying ought preferably to take place at temperatures below 100° C. In order to prevent sticking, a suitable release agent can be used for this step. The associative thickener (6) of the invention is obtained as a powder.

Further details relating to the gel polymerization procedure are disclosed for example in DE 10 2004 032 304 A1, paragraphs [0037] to [0041].

Associative thickeners (β) of the invention in the form of alkali-soluble, aqueous dispersions can be prepared preferably by means of emulsion polymerization. The performance of an emulsion polymerization using hydrophobically associating monomers is disclosed for example in WO 2009/019225 page 5, line 16 to page 8, line 13.

With regard to the associative thickener (β) for preferred use in accordance with the present invention, and to its preparation, reference is additionally made to patent application WO 2014/095621, whose content is hereby incorporated fully into the present specification.

Additionally, the associative thickener (β) of the invention may comprise HASE rheology additives (hydrophobically modified alkali-soluble emulsion) or HEUR rheology additives (hydrophobically modified ethylene oxide urethane).

The at least one associative thickener (β) has an average molecular weight of 200 000 to 30 000 000 g/mol, more preferably 250 000 to 15 000 000 g/mol, and very preferably 300 000 to 8 000 000 g/mol. The average molecular weight M_{w} of the associative thickener (β) of the invention was determined by the Mark-Houwink relationship (1).

In one preferred embodiment, the composition of the invention comprises 5 to 95 wt %, preferably 20 to 95 wt %, especially preferably 80 to 95 wt % of the at least one water-soluble polymer (α) and 5 to 95 wt %, preferably 5 to 60 wt %, especially preferably 5 to 20 wt % of the at least one associative thickener (β). The composition of the invention is preferably in the form of a powder.

A further subject of the present specification is a mixture comprising an inorganic binder and 0.01 to 10 wt % of the composition of the invention, based on the dry mass of the mixture.

In particular, the mixture of the invention, based on its dry mass, comprises at least 20 wt %, preferably at least 40 wt %, more particularly from 30 to 99.99 wt %, and especially preferably from 35 to 55 wt % of the at least one inorganic binder and 0.01 to 10 wt %, preferably 0.01 to 2 wt %, especially preferably 0.02 to 1 wt % of the composition of the invention based on the at least one water-soluble polymer (α) and the at least one associative thickener (β).

In one preferred embodiment the inorganic binder of the invention comprises at least one binder from the series consisting of calcium sulfate n-hydrate (n=0-2), Portland cement, white cement, calcium aluminate cement, calcium sulfoaluminate cement, geopolymer, and latent hydraulic and/or pozzolanic binder such as, for example, flyash, metakaolin, silica dust, and slag sand. Particularly preferred are cement based on Portland cement, calcium sulfate hemihydrate, calcium sulfate anhydrite, and calcium aluminate cement.

The mixture of the invention may in particular comprise mixtures in powder form which are subsequently mixed with water.

In an additionally preferred embodiment, the mixture of the invention comprises an inorganic filler. The inorganic filler may preferably comprise at least one filler from the series consisting of silica sand, finely ground quartz, limestone, heavy spar, calcite, dolomite, talc, kaolin, mica, and chalk.

In one specific embodiment the mixture of the invention, based on its dry mass, consists to an extent of at least 80 wt %, more particularly at least 90 wt %, and more preferably more than 95 wt % of an inorganic binder and an inorganic filler.

In one particularly preferred embodiment, the mixture of the invention comprises a factory dry-mix mortar, more particularly masonry mortars, render mortars, mortars for thermal insulation composite systems, renovating renders, jointing mortars, tile adhesives, thin-bed mortars, screed mortars, casting mortars, injection mortars, filling compounds, grouts, or lining mortars.

As a result of continual effort toward extensive rationalization and improved product quality, mortars for a very wide variety of different uses within the construction sector are nowadays hardly any longer mixed together from the starting materials on the building site itself. This function is nowadays largely carried out by the construction materials industry in the factory, and the ready-to-use mixtures are provided in the form of what are called factory dry-mix mortars. Finished mixtures which can be made workable on site exclusively by addition of water and mixing are referred to, according to DIN 18557, as factory mortars, more particularly as factory dry-mix mortars. Mortar systems of this kind may fulfill any of a very wide variety of physical construction objectives. Depending on the objective that exists, the binder is admixed with further additives or admixtures in order to adapt the factory dry-mix mortar to the specific application. The additives and admixtures in question may comprise, for example, shrinkage reducers, expansion agents, accelerators, retardants, dispersants, defoamers, air entrainers, and corrosion inhibitors.

In one particular embodiment, the mixture of the invention may also be a self-leveling compound.

The mixture of the invention may in particular be present, therefore, in the form of a dry mortar. The present specification here also encompasses a method for producing the mixture of the invention wherein the composition of the invention is contacted by mixing with the at least one inorganic binder and, optionally, further components. In this case the composition of the invention is present in particular in the form of a powder.

For dry mortar applications, the composition of the invention is used preferably in powder form. In this case it is preferred for the size distribution of the particles to be selected such that the average particle diameter is less than 100 μm and the fraction of particles having a particle diameter greater than 200 μm is less than 2 wt %. Preferred powders are those for which average particle diameter is less than 60 μm and the fraction of particles having a particle diameter greater than 120 μm is less than 2 wt %. Particularly preferred powders are those for which average particle diameter is less than 50 μm and the fraction of particles having a particle diameter greater than 100 μm is less than 2 wt %. The particle diameter of the composition of the invention in powder form may be brought to the preferred size distributions by means, for example, of grinding.

The inorganic binder may in one preferred embodiment be calcium sulfate n-hydrate (n=0 to 2), also referred to below as gypsum. The expression “gypsum” is used synonymously in the present context with calcium sulfate, and the calcium sulfate may be present in its various anhydrous and hydrated forms with and without water of crystallization. Natural gypsum substantially comprises calcium sulfate dihydrate (“dihydrate”). The natural form of calcium sulfate, free of water of crystallization, is encompassed by the expression “anhydrite”. As well as the naturally occurring forms, calcium sulfate is a typical byproduct of industrial processes, and is then referred to as “synthetic gypsum”. A typical example of a synthetic gypsum from industrial processes is flue gas desulfurization. Synthetic gypsum, however, may equally also be formed as a byproduct of phosphoric acid or hydrofluoric acid preparation processes. Typical gypsum (CaSO₄×2 H₂O) may be calcined, with the water of crystallization being removed. Products of a wide variety of different calcining processes are α- or β-hemihydrate. β-Hemihydrate results from rapid heating in open vessels, accompanied by simultaneously rapid evaporation of water, forming voids. α-Hemihydrate is produced by the dewatering of gypsum in closed autoclaves. The crystal habit in this case is relatively impervious, and so this binder requires less water for liquefaction than does β-hemihydrate. On the other hand, hemihydrate undergoes rehydration with water to form dihydrate crystals. Gypsum hydration customarily takes from several minutes to hours, resulting in a shortened working time as compared with cements, which require several hours to days for complete hydration. These qualities make gypsum a useful alternative to cements as binders in a wide variety of areas. Moreover, fully cured gypsum products exhibit pronounced hardness and compressive strength.

For a wide variety of fields of application, β-hemihydrate is selected, since it is more readily available and exhibits numerous advantages from economic standpoints. However, these advantages are partly undone by the fact that β-hemihydrate on being worked has a relatively high water demand in order for flowable suspensions to be obtained at all. Moreover, the dried gypsum products produced therefrom tend toward a certain weakness, attributable to quantities of residual water which have remained in the crystal matrix during curing. For this reason, corresponding products exhibit a lower hardness than gypsum products prepared with relatively small amounts of mixing water.

With particular preference, therefore, for the purposes of the present invention, the calcium sulfate n-hydrate is β-calcium sulfate hemihydrate. β-calcium sulfate hemihydrate of the invention here is especially suitable for use in gypsum-based self-leveling screed.

With additional preference the inorganic binder may be a geopolymer. Geopolymers are inorganic binder systems based on reactive, water-insoluble compounds based on SiO₂ in conjunction with Al₂O₃, which cure in an aqueous-alkaline medium. Specific geopolymer compositions are described for example in U.S. Pat. No. 4,349,386, WO 85/03699, and U.S. Pat. No. 4,472,199. The reactive oxide or oxide mixture used in this case may among others be microsilica, metakaolin, aluminosilicates, flyashes, activated clay, pozzolans or mixtures thereof. The alkaline medium for the activation of the binders consists customarily of aqueous solutions of alkali metal carbonates, alkali metal fluorides, alkali metal hydroxides, alkali metal aluminates and/or alkali metal silicates such as soluble water glass, for example. In comparison to Portland cement, geopolymers may be more favorably priced and more resistant, especially with respect to acids, and may have a more favorable CO₂ emissions balance.

The mixture of the invention may in particular also comprise a binder mixture. The reference here, in the presence context, is in particular to mixtures of at least two binders from the series consisting of cement, pozzolanic and/or latent hydraulic binder, white cement, specialty cement, calcium aluminate cement, calcium sulfoaluminate cement, geopolymer, and the various hydrous and anhydrous calcium sulfates.

For the purposes of the present invention, the mixture of the invention may be in dry form, this meaning that it has a Karl-Fischer water content of less than 5 wt %, preferably less than 1 wt %, and more preferably of less than 0.1 wt %.

It is preferred for the mixture of the invention to have an average particle size of between 0.1 and 1000 μm, more preferably between 1 and 200 μm. The particle size in this context is determined by laser diffractometry.

A further subject of the present specification is the use of the composition of the invention in a mixture comprising an inorganic binder and 0.01 to 10 wt % of the composition of the invention, based on the dry mass of the mixture, as rheological additive. The composition of the invention may be used more particularly for reducing the segregation, sedimentation, and bleeding of the composition during the resting phase of the mixture, with high flowability during working being achieved at the same time.

The examples which follow are intended to illustrate the invention in more detail.

### EXAMPLES

Preparation of Monomer M1:

A 2 l pressure autoclave with anchor stirrer was charged with 135.3 g (1.16 mol) of hydroxybutyl vinyl ether (HBVE) (stabilized with 100 ppm potassium hydroxide (KOH)) and the stirrer was engaged. 1.06 g of potassium methoxide (KOMe) solution (32% KOMe in methanol (MeOH), corresponding to 0.0048 mol of potassium) were run in and the stirred vessel was evacuated to a pressure of less than 10 mbar, heated to 80° C., and operated for 70 minutes at 80° C. under a pressure of less than 10 mbar. MeOH was removed by distillation.

In an alternative procedure, the potassium methoxide (KOMe) solution (32% KOMe in methanol (MeOH)) was run in and the stirred vessel was evacuated to a pressure of 10-20 mbar, heated to 65° C., and operated for 70 minutes at 65° C. under a pressure of 10-20 mbar. MeOH was removed by distillation.

The vessel was flushed three times with N₂ (nitrogen). Thereafter the vessel was checked for pressure tightness, a superatmospheric pressure of 0.5 bar (1.5 bar absolute) was established, and heating took place to 120° C. The pressure was released to 1 bar absolute, and 1126 g (25.6 mol) of ethylene oxide (EO) were metered in up to a pₘₐₓ of 3.9 bar absolute and a Tₘₐₓ of 150° C. Following addition of 300 g of EO, metering was interrupted (about 3 hours after the start) and, after a 30-minute pause, the vessel was let down to 1.3 bar absolute. Thereafter the remaining EO was metered in. The metering of EO, including let down, lasted for 10 hours in all.

Stirring was continued up to constant pressure at about 145-150° C. (1 h), followed by cooling to 100° C. and removal of low boilers under a pressure of less than 10 mbar for 1 hour. This gave a hydroxybutyl vinyl ether alkoxylate having 22 EO units.

A 2 l pressure autoclave with anchor stirrer was charged with 588.6 g (0.543 mol) of hydroxybutyl vinyl ether alkoxylate having 22 EO units, and the stirrer was switched on. Then 2.39 g of 50% strength NaOH solution (0.030 mol of NaOH, 1.19 g of NaOH) were added, reduced pressure of <10 mbar was applied, and the contents of the autoclave were heated to 100° C. and held for 80 minutes in order for the water to be distilled off.

The autoclave was flushed three times with N₂. Thereafter the container was tested for pressure tightness, a superatmospheric pressure of 0.5 bar (1.5 bar absolute) was set, heating took place to 127° C., and thereafter the pressure was adjusted to 1.6 bar absolute. 59.7 g (1.358 mol) of EO were metered in at 127° C., the pₘₐₓ being 3.9 bar absolute. After a 30-minute pause, constant pressure was established, after which let down took place to 1.0 bar asbsolute. 625.5 g (8.688 mol) of BuO (butylene oxide) were metered in at 127° C., the pₘₐₓ being 3.1 bar absolute. Interim let down was needed in view of the increase in fill level. The BuO metering was halted, reaction was continued for an hour until the pressure was constant, and the vessel was let down to 1.0 bar absolute. Thereafter the metering of BuO was continued. Pₘₐₓ was still 3.1 bar (first let down after 610 g of BuO, total BuO metering time 8 h including let down pause). After the end of the BuO metering, reaction was continued for 8 hours, followed by heating to 135° C. Thereafter 83.6 g (1.901 mol) of ED were metered in at 135° C., the pₘₐₓ being 3.1 bar absolute. After the end of the EO metering, reaction was continued for 4 hours. Cooling took place to 100° C.; residual oxide was drawn off until the pressure was below 10 mbar for at least 10 minutes. Then 0.5% of water was added at 120° C., and subsequent removal until the pressure was below 10 mbar for at least 10 minutes. The reduced pressure was eliminated with N2, followed by addition of 100 ppm of butylated hydroxytoluene (BHT). The product was discharged at 80° C. under N2.

This gave a hydroxybutyl vinyl ether alkoxylate having 24.5 EO units, 16 BuO units, and 3.5 EO units (monomer M1). Analysis (mass spectrum, GPC, ¹H NMR in CDCl₃, ¹H NMR in MeOD) confirmed the structure.

### Example 1

A glass reactor equipped with stirrer, pH electrode, thermometer, redox electrode was charged with 141.0 g of deionized water and 148.50 g of vinyloxybutylpolyethylene glycol 1100 (VOBPEG 1100) and 37.50 g of HBVE-24.5EO-16BuO-3.5EO (monomer M1) and this initial charge was cooled to a polymerization start temperature of 15° C. (initial charge).

In a separate feed vessel, 32.59 g of acrylic acid (99.5%) were mixed homogenously with 97.12 g of deionized water and 13.69 g of 50% KOH (solution A).

In parallel a 3% solution of a mixture of sodium sulfite, the disodium salt of 2-hydroxy-2-sulfinatoacetic acid, and the disodium salt of 2-hydroxy-2-sulfonatoacetic acid (Brüggolit FF6 from Brüggemann GmbH) in water was prepared (solution B). With stirring and cooling, first 47.1 g of solution A were added to the initial charge, after which 1.22 g of 3-mercaptopropionic acid (MPA) were added to the remainder of solution A. Then, in succession, 0.30 g of 3-mercaptopropionic acid and 0.047 g of iron(II) sulfate heptahydrate (FeSO₄) were added to the initial charge solution. That solution was subsequently set to a starting pH of 5.7 using NaOH (50%). 0.3 ml of solution B was added to the initial charge.

With the addition of 2.87 g of hydrogen peroxide (30% solution in water) to the initial charge mixture, the reaction was initiated. At the same time, the addition of solution A and solution B to the stirred initial charge was commenced. Solution A was added over 45 minutes. Solution B was added in parallel at a constant metering rate of 18 ml/h until peroxide was no longer detectable in the solution. Thereafter the resulting polymer solution was adjusted to a pH of 6.5 using 50% sodium hydroxide solution.

The resulting copolymer was obtained in a solution having a solids content of 40.9 wt %. The weight-average molar mass of the copolymer is 33 200 g/mol, the polydispersity 2.10.

Examples 2 to 5 and also C1 and C2 were carried out in the same way as example 1, the quantities used being evident from tables 1 and 2.

TABLE 1
Quantities used for the initial charge for synthesis of
the inventive water-soluble polymers.

| | Initial charge | | | | | |
|---|---|---|---|---|---|---|
| | | | HBVE- | HBVE- | HBVE- | |
| | | | 24.5EO- | 24.5EO- | 24.5EO- | |
| | VOBPEG | VOBPEG 500 | 16BuO- | 22BuO- | 10PO-3.5EO | H₂O deionized |
| Example | 1100 [g] | [g] | 3.5EO [g] | 3.5EO [g] | [g] | [g] |
| 1 | 148.50 | | 37.50 | | | 141.0 |
| 2 | 74.25 | | | 21.99 | | 73.0 |
| 3 | | 67.50 | 37.50 | | | 95.0 |
| 4 | 74.25 | 33.75 | 37.50 | | | 130.0 |
| 5 | 152.63 | | 28.13 | | | 137.0 |
| C1 | 148.50 | | | | 28.92 | 134.0 |
| C2 | 165.00 | | | | | 125.0 |

C = Comparative example

TABLE 2
Quantities used for synthesis of the inventive water-soluble polymers.

| | | | | Initial | | | | |
|---|---|---|---|---|---|---|---|---|
| | Solution A | | | fraction of | MPA | | | |
| | | | KOH | monomer | (to | | | |
| | | | (50%) | solution A | solution | FeSO₄ | H₂O₂ | |
| Example | AA [g] | H₂O [g] | [g] | [ml] | A) [g] | [g] | [g] | MPA [g] |
| 1 | 32.59 | 97.12 | 13.69 | 47.1 | 1.22 | 0.047 | 2.87 | 0.30 |
| 2 | 16.29 | 48.56 | 6.84 | 23.6 | 0.61 | 0.023 | 1.44 | 0.15 |
| 3 | 32.59 | 97.12 | 13.69 | 47.1 | 1.68 | 0.028 | 1.72 | 0.78 |
| 4 | 32.59 | 97.12 | 13.69 | 47.1 | 1.68 | 0.028 | 1.72 | 0.78 |
| 5 | 32.59 | 97.12 | 13.69 | 47.1 | 1.22 | 0.047 | 2.87 | 0.30 |
| C1 | 32.59 | 97.12 | 13.69 | 47.1 | 1.22 | 0.047 | 2.87 | 0.30 |
| C2 | 32.59 | 97.12 | 13.69 | 41.7 | 1.22 | 0.047 | 2.87 | 0.30 |

[g] = grams;
[ml] = milliliters;
AA = 99.5% acrylic acid;
MPA = 3-mercaptopropionic acid;
H₂O₂ = 30%

TABLE 3
Overview of analytical data.

| Example | Mw g/mol* | PD* | Solids wt % |
|---|---|---|---|
| 1 | 33 200 | 2.10 | 40.9 |
| 2 | 41 100 | 1.98 | 39.6 |
| 3 | 15 500 | 1.66 | 29.9 |
| 4 | 18 300 | 1.57 | 28.6 |
| 5 | 40 500 | 2.17 | 40.4 |
| C1 | 34 700 | 1.83 | 41.7 |
| C2 | 26 600 | 1.66 | 40.7 |

*Mw (average molecular weight) and PD (polydispersity) determined by gel permeation chromatography (GPC):
Column combinations: Shodex OHpak SB 804HQ from Showa, Japan (polyhydroxymethacrylate gel, particle size 10 μm, pore size 2000 Å, plate number >16 000, column diameter and length 8 mm × 300 mm) and Shodex OHpak 802.5HQ from Showa, Japan (polyhydroxymethacrylate gel, particle size 6 μm, pore size 200 Å, plate number >16 000, column diameter and length 8 mm × 300 mm); eluent: 0.05M ammonium formate/methanol (80/20 vol %), pH 6.5; flow rate: 0.5 ml/min; column temperature: 50° C.; detection: RI; calibration: PEG/PEO standards in the 10e6-10e2 g/mol range.

Synthesis of the Associative Thickener:

A plastic pail with magnetic stirrer, pH meter, and thermometer was charged with 53.8 g of a 50% aqueous solution of acrylamido-2-methylpropanesulfonic acid, Na salt, after which, in succession, 148 g of distilled water, 0.4 g of a commercial silicone-based defoamer (Dow Corning® Antifoam Emulsion RD), 6.1 g of HBVE-24.5EO-16BuO-3.5EO (monomer M1), 185.5 g of acrylamide (50% solution in water), 1.2 g of a 5% aqueous solution of diethylenetriaminepentaacetic acid, pentasodium salt, and 0.5 g of sodium hypophosphite (10% solution in water) were added.

Following adjustment to a pH of 6.5 using 20% sodium hydroxide solution, and following addition of the remaining water to achieve the target monomer concentration of 31% (total amount of water minus the amount of water already added, minus the required amount of acid), the monomer solution was set to the starting temperature of 4° C. The solution was transferred to a Thermos flask, the temperature sensor for temperature recording was mounted, flushing with nitrogen was carried out for 45 minutes, and polymerization was initiated using 4 g of a 4% methanolic solution of the azo initiator 2,2′-azobis(2-methylpropionitrile), 0.4 g of a 1% tert-butyl hydroperoxide solution, and 0.4 g of a 1% sodium sulfite solution. With the onset of the polymerization, the temperature rose to 80-90° C. within about 25 minutes. A solid polymer gel was obtained.

After having cooled to about 50° C., the block of gel was comminuted using a mincer, and the gel granules obtained were dried in a fluidized-bed dryer at 55° C. for two hours. This gave hard, white granules which were converted to a powder state using a centrifugal mill.

Average molecular weight of the associative thickener: 7 000 000 g/mol.

The average molecular weight of the associative thickener was determined, as already described, by way of the Mark-Houwink relationship (1). For the present polymer/solvent pairing, the parameters K and α are unknown. The parameters used were therefore those for pure polyacrylamide in water (according to J. Klein, K-D. Conrad, Makromol. Chem. 1980, 18, 227), i.e., K=0.0049 and α=0.8.

For determining the intrinsic viscosity [η] a 0.5% solution of the copolymer in water was prepared. This solution was diluted with a buffer (116.66 g of NaCl+32.26 g of Na₂HPO₄*12H₂O+1.795 g of Na₂HPO₄*H₂O in 2 liters of demineralized water) to give a c=0.01% polymer solution. This solution was analyzed with an Ubbelohde viscometer (at 20° C.; Ubbelohde capillary type 1). The intrinsic viscosity was determined from the transit time of the 0.01% polymer solution, the reference used being the solvent without polymer.

The transit time (t(polymer)) of the polymer solution was determined in comparison to the pure solvent (tₛᵥ) as reference (Δt=t(polymer)−tₛᵥ). The intrinsic viscosity [η] can be calculated from this according to Solomon-Ciuta:

[η]={square root over (2(vᵣₑₗₐₜᵢᵥₑ−1)−2lnvᵣₑₗₐₜᵢᵥₑ))}/c

where vᵣₑₗₐₜᵢᵥₑ=c×v_{reduced}+1

and v_{reduced}=Δt/(c×tₛᵥ)

Performance Tests

The self-leveling calcium sulfate screed was composed of 39.55 wt % of anhydrite and 60.0 wt % of standard sand (DIN EN 196-1). As an initiator, 0.45 wt % of potassium sulfate was added. The water content was 14.0 wt %, based on the amount of anhydrite, standard sand, and potassium sulfate, corresponding to a water-to-binder ratio of 0.35. To plasticize the self-leveling calcium sulfate screed, a water-soluble polymer according to table 3 was added. The amount of the water-soluble polymer was selected relative to the anhydrite content in such a way that the self-leveling calcium sulfate screed, without the addition of an associative thickener, 5 minutes after addition of water, achieved a Hagermann cone slump flow of 325±5 mm.

The self-leveling calcium sulfate screeds were produced in a method based on DIN EN 196-1:2005 in a mortar mixer with a capacity of approximately 5 liters. For mixing up, water, water-soluble polymer, associative thickener, an initiator, and anhydrite were placed into the mixing vessel. Immediately thereafter the mixing operation was commenced, with the fluidizer at low speed (140 revolutions per minute (rpm)). After 30 seconds, the standard sand was added at a uniform rate within 30 seconds to the mixture. Thereafter the mixer was switched to a higher speed (285 rpm) and mixing was continued for 30 seconds more. After that the mixer was stopped for 90 seconds. During the first 30 seconds, the self-leveling calcium sulfate screed, which stuck to the wall and to the lower part of the bowl, was removed with a rubber scraper and put into the middle of the bowl. After the wait, the self-leveling calcium sulfate screed was mixed for a further 60 seconds at the higher mixing speed. The total mixing time was 4 minutes.

Immediately after the end of the mixing operation, the slump flow was determined on all samples using the Hägermann cone, with no compaction energy being supplied, in accordance with the SVB guidelines of the Deutscher Ausschuss für Stahlbeton [German Reinforced Concrete Committee] (see: Deutscher Ausschuss für Stahlbetonbau (ed.): DAfStb Guidelines for Self-compacting Concrete (SVB guidelines), Berlin, 2003). The Hägermann cone (d top=70 mm, d bottom=100 mm, h=60 mm) was placed centrally on a dry glass plate having a diameter of 400 mm and was filled with the self-leveling calcium sulfate screed up to the level intended. Immediately after leveling had taken place, or 5 minutes after the first contact between anhydrite and water, the Hägermann cone was taken off, held over the slumping self-leveling calcium sulfate screed for 30 seconds to allow for dripping, and then removed. As soon as the slump flow came to a standstill, the diameter was determined, using a caliper gauge, at two axes lying at right angles to one another, and the average was calculated. The slump flow was tested in order, as described above, for all samples to be adjusted to the same fluid consistency by varying the amount of water-soluble polymer.

Additionally, a determination was made of the yield point using a rotational rheometer from

Schleibinger, model Viskomat NT, with a vane cell, at low shear rates, as occur during flow of self-leveling calcium sulfate screed. The purpose of determining the yield point was to provide information on possible flocculation of the anhydrite particles. For this purpose, after mixing, in parallel with the test of the slump flow, the self-leveling calcium sulfate screed was introduced into the measuring vessel, which was inserted into the rotational rheometer. Immediately thereafter the measuring head of the rheometer was lowered, the internal rigid sensor of the vane cell was immersed into the sample within the measuring vessel, and rheological measurement was commenced at an age of 5 minutes. In order to undo the resting structure, the sample was subjected to preliminary shearing at a shear rate of 50 s⁻¹ for 30 seconds. This was followed by determination of the yield point under rate control in steps of 25, 10, 5, 2.5, and 1.0 s⁻¹ for 10 seconds in each case. The dynamic yield point was evaluated using the known Bingham model τ=τₙ+μ·\dot{γ}.

In order to characterize the effect of the combination of water-soluble polymer and associative thickener on the robustness of the self-leveling calcium sulfate screed with respect to sedimentation and bleeding (settling of water on the surface), 200 ml of the self-leveling calcium sulfate screed, after having been mixed up, were introduced into a glass cylinder with a diameter of 35 mm (see: A. Perrot et al./Cement and Concrete Research 42 (2012) pp. 937-944). After rest times of 30, 60, and 120 minutes, the height of the water film (bleed water) on the surface of the self-leveling calcium sulfate screed was measured. The higher the film of water on the surface of the mortar, the lower the stabilizing effect of the associative thickener used. The results are summarized in table 4.

TABLE 4
Results of the performance trials

| | Amount of | | | | | | | |
|---|---|---|---|---|---|---|---|---|
| | water- | Amount of | | | | | | |
| | soluble | associative | | | | | | |
| | polymer | thickener | | | | | | |
| Water- | added | added | Slump | | | | | |
| soluble | [% based on | [% based on | flow | Yield | Height of water film in [mm] after | | | |
| polymer | anhydrite] | anhydrite] | [cm] | point [Pa] | 0 min | 30 min | 60 min | 120 min |
| 1 | 0.22 | 0 | 33.0 | 11.0 | 0.00 | 0.00 | 0.25 | 0.29 |
| | 0.22 | 0.02 | 30.2 | 46.1 | 0.00 | 0.00 | 0.00 | 0.00 |
| 2 | 0.25 | 0 | 32.5 | 9.44 | 0.00 | 0.10 | 0.15 | 0.37 |
| | 0.25 | 0.02 | 24.6 | 53.0 | 0.00 | 0.00 | 0.00 | 0.00 |
| 3 | 0.32 | 0 | 32.0 | 12.3 | 0.00 | 0.00 | 0.15 | 0.26 |
| | 0.32 | 0.02 | 21.0 | 109.4 | 0.00 | 0.00 | 0.00 | 0.01 |
| 4 | 0.27 | 0 | 32.3 | 12.4 | 0.00 | 0.00 | 0.15 | 0.26 |
| | 0.27 | 0.02 | 23.8 | 52.6 | 0.00 | 0.00 | 0.00 | 0.03 |
| 5 | 0.18 | 0 | 32.5 | 11.5 | 0.00 | 0.03 | 0.07 | 0.20 |
| | 0.18 | 0.02 | 22.4 | 63.2 | 0.00 | 0.00 | 0.00 | 0.00 |
| C1 | 0.15 | 0 | 32.0 | 11.5 | 0.00 | 0.00 | 0.08 | 0.24 |
| | 0.15 | 0.02 | 24.9 | 31.4 | 0.00 | 0.00 | 0.07 | 0.11 |
| C2 | 0.12 | 0 | 32.8 | 10.9 | 0.00 | 0.00 | 0.12 | 0.39 |
| | 0.12 | 0.02 | 30.0 | 22.7 | 0.00 | 0.00 | 0.04 | 0.12 |

It can be seen that the combination of inventive water-soluble polymer and the associative thickener exhibits advantages relative to the prior art.

1. A composition comprising
(α) at least one water-soluble polymer based on
(a) 5 to 40 wt % of at least one monomer of the formula (I),
Z—R¹—O—(—CH₂—CH₂—O—)ₖ—(—CH₂—CH(R²)—O—)ₗ—(—CH₂—CH₂—O—)ₘ—R³ (I)
where the units —(—CH₂CH₂—O—)ₖ, —(—CH₂—CH(R²)—O—)ₗ and —(—CH₂—CH₂—O—)ₘ, where present, are arranged in block structure in the sequence shown in formula (I), and the radicals have the following definitions:
Z: is an organic radical having at least one polymerizable structural group;
k: is a number from 10 to 150;
l: is a number from 1 to 25;
m: is a number from 0 to 15;
R¹: is independently at each occurrence a single bond or a divalent linking group selected from the group consisting of —(CₙH₂ₙ)—, —O—(C_{n′}H_{2n′})— and —C(O)—O—(C_{n″}H_{2n″})—, where n, n′ and n″ are a natural number from 1 to 6;
R²: is a hydrocarbyl radical having at least 2 carbon atoms, or an ether group of the general formula —CH₂—O—R^{2′}, where R^{2′} is a hydrocarbyl radical having at least 2 carbon atoms and where R² within the group —(—CH₂—CH(R²)—O—)ₗ may be identical or different;
R³: is independently at each occurrence H or a hydrocarbyl radical having 1 to 24 carbon atoms, and also
(b) 5 to 95 wt % of at least one polymerizable monomer (b), which is different from monomer (a) and comprises acid groups, and
(β) at least one associative thickener,
where the associative thickener (β) has an average molecular weight of 200,000 g/mol to 30,000,000 g/mol, as determined by the Mark-Houwink relationship (1),
M=([η]/K)^{1/α} (1)
where K=0.0049, α=0.8, └η┘ is the intrinsic viscosity, and M is the average molecular weight, and
the water-soluble polymer (α) has an average molecular weight of 5000 to 100,000 g/mol, as determined by gel permeation chromatography.

2. The composition according to claim 1, wherein the acid group of the monomer (b) comprises at least one acid group from the group consisting of carboxyl, phosphono, sulfino, sulfo, sulfamido, sulfoxy, sulfoalkyloxy, sulfinoalkyloxy, and phosphonooxy.

3. The composition according to claim 1, wherein the at least one water-soluble polymer (a) is a polycondensation product based on
(a) at least one monomer of the formula (I), where Z is an aromatic or heteroaromatic, and
(b) where the monomer (b) is phosphated or sulfonated and has an aromatic or heteroaromatic as the polymerizable group.

4. The composition according to claim 3, wherein
Z in formula (I) is identical or different and is represented by a substituted or unsubstituted, aromatic or heteroaromatic compound having 5 to 10 carbon atoms in the aromatic system, and
(b) is represented by the following general formula (II) 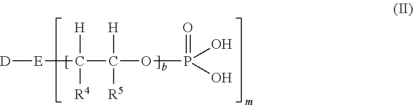
where
D is identical or different and is represented by a substituted or unsubstituted, aromatic or heteroaromatic compound having 5 to 10 carbon atoms in the aromatic system,
where
E is identical or different and is represented by N, NH or O,
where
m=2 if E=N and m=1 if E=NH or O,
where
R⁴ and R⁵ independently of one another are identical or different and are represented by a branched or unbranched C₁ to C₁₀ alkyl radical, C₅ to C₈ cycloalkyl radical, aryl radical, heteroaryl radical or H,
where b
is identical or different and is represented by an integer from 0 to 300.

5. The composition according to claim 4, wherein water-soluble polymer (α) is a polycondensation product which comprises a structural unit (III) which is represented by the following formula 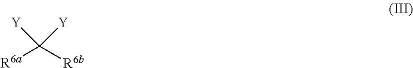
where
R^{6a} and R^{6b} independently of one another are identical or different and are represented by H, CH₃, COOH or a substituted or unsubstituted, aromatic or heteroaromatic compound having 5 to 10 carbon atoms, and
Y independently at each occurrence is identical or different and is represented by structural units which correspond to formula (I) and formula (II), or other constituents of the polycondensation product.

6. The composition according to claim 1, wherein the water-soluble polymer (α) is at least one copolymer based on
(a) at least one monomer of the formula (I), where Z is an ethylenically unsaturated radical and
(b) where the monomer (b) has at least one ethylenically unsaturated radical.

7. The composition according to claim 6, wherein the ethylenically unsaturated monomer (b) is represented by at least one of the following general formulae from the group consisting of (IV), (V) and (VI) 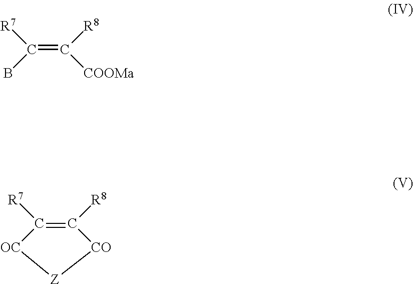
where
R⁷ and R⁸ independently of one another are hydrogen or an aliphatic hydrocarbyl radical having 1 to 20 carbon atoms
B is H, —COOMₐ, —CO—O(C_{q}H_{2q}O)ᵣ—R⁹, or —CO—NH—(C_{q}H_{2q}O)ᵣ—R⁹
M is hydrogen, a mono- or divalent metal cation, ammonium ion or an organic amine radical
a is ½ or 1
R⁹ is hydrogen, an aliphatic hydrocarbyl radical having 1 to 20 carbon atoms, a cycloaliphatic hydrocarbyl radical having 5 to 8 carbon atoms, or an optionally substituted aryl radical having 6 to 14 carbon atoms
q independently at each occurrence for each (C_{q}H_{2q}O) unit identically or differently is 2, 3 or 4, and
r is 0 to 200
Z is O, NR³, 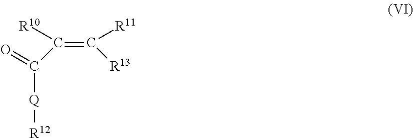
where
R¹⁰ and R¹¹ independently of one another are hydrogen or an aliphatic hydrocarbyl radical having 1 to 20 carbon atoms, a cycloaliphatic hydrocarbyl radical having 5 to 8 carbon atoms, or an optionally substituted aryl radical having 6 to 14 carbon atoms
R¹² is identical or different and is represented by (CₙH₂ₙ)—SO₃H with n=0, 1, 2, 3 or 4, (CₙH₂ₙ)—OH with n=0, 1, 2, 3 or 4; (CₙH₂ₙ)—PO₃H₂ with n=0, 1, 2, 3 or 4, (CₙH₂ₙ)—OPO₃H₂ with n=0, 1, 2, 3 or 4, (C₆H₄)—SO₃H, (C₆H₄)—PO₃H₂, (C₆H₄)—OPO₃H₂ and (CₙH₂ₙ)—NR¹⁴_{b} with n=0, 1, 2, 3 or 4 and b=2 or 3
R¹³ is H, —COOMₐ, —CO—O(C_{q}H_{2q}O)ᵣ—R⁹, or —CO—NH—(C_{q}H_{2q}O)ᵣ—R⁹, where Mₐ, R⁹, q and r possess definitions stated above
R¹⁴ is hydrogen, an aliphatic hydrocarbyl radical having 1 to 10 carbon atoms, a cycloaliphatic hydrocarbyl radical having 5 to 8 carbon atoms, or an optionally substituted aryl radical having 6 to 14 carbon atoms
Q is identical or different and is represented by NH, NR¹³ or O;
where R¹⁵ is an aliphatic hydrocarbyl radical having 1 to 10 carbon atoms, a cycloaliphatic hydrocarbyl radical having 5 to 8 carbon atoms, or an optionally substituted aryl radical having 6 to 14 carbon atoms.

8. The composition according to claim 6, wherein Z in formula (I) is represented by at least one radical of the formula (VII) 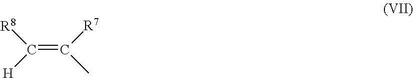
in which
R⁷ and R⁸ have the definitions stated above.

9. The composition according to claim 1, wherein the at least one associative thickener (β) comprises
at least one water-soluble copolymer based on
(c) 0.1 to 35 wt % of at least one monomer of the formula (VIII),
H₂C═C(R¹⁷)—R¹—O—(—CH₂—CH₂—O—)ₖ—(—CH₂—CH(R²)—O—)ₗ—(—CH₂—CH₂—O—)ₘ—R³ (VIII)
where the units —(—CH₂—CH₂—O—)ₖ, —(—CH₂—CH(R²)—O—)ₗ and —(—CH₂—CH₂—O—)ₘ, where present, are arranged in block structure in the sequence shown in formula (VIII), and where R¹⁷: is H or methyl;
and the remaining radicals have the definitions stated in formula (I), and
(d) 10 to 99.9 wt % of at least one hydrophilic monomer (d) which is different from monomer (c).

10. The composition according to claim 1, wherein the radicals of the monomer of the formula (VIII) have the following definition:
k: is a number from 23 to 26;
l: is a number from 14 to 20;
m: is a number from 2 to 5;
R¹: is a divalent linking group —O—(C_{n′}H_{2n′})—, where n′ is 4,
R²: is a hydrocarbyl radical having 2 carbon atoms;
R³: is H, and
R¹⁷: is H.

11. The composition according to claim 1, which comprises 5 to 95 wt % of the at least one water-soluble polymer (a) and 5 to 95 wt % of the at least one associative thickener (β).

12. A mixture comprising an inorganic binder and 0.01 to 10 wt % of a composition according to claim 1, based on the dry mass of the mixture.

13. A process comprising mixing the composition according to claim 1 in a mixture comprising an inorganic binder and 0.01 to 10 wt % of the composition, based on the dry mass of the mixture, as a rheological additive.
